(19) United States
(12) Patent Application Publication
(10) Pub. No.: US 2019/0002101 A1
(43) Pub. Date: Jan. 3, 2019

(54) SECURE WIRE-BASED SYSTEM FOR A DRONE

(71) Applicants: Timothée Penet, Lyon (FR); Guilhem de Marliave, Lyon (FR); Olivier Dubois, Lyon (FR)

(72) Inventors: Timothée Penet, Lyon (FR); Guilhem de Marliave, Lyon (FR); Olivier Dubois, Lyon (FR)

(21) Appl. No.: 15/576,727

(22) PCT Filed: Jun. 13, 2016
(86) PCT No.: PCT/IB2016/053470

§ 371 Date: Nov. 27, 2017

(30) Foreign Application Priority Data
Jun. 15, 2015 (FR) FR20150001237

(51) Int. Cl. B64C 39/02; B64F 3/02; H02G 11/02; B65H 75/30

(52) U.S. Cl. CPC B64C 39/022; B64C 39/024; B64F 3/02; B64C 2201/042; B65H 75/30; B64C 2201/148; H02G 11/02

(57) ABSTRACT

The invention relates to a secure wire-based system for a drone. Said system ensures suitable traction on the wire during normal control of the drone and automatically locks the wire to a maximum length predefined by the user. The locking is in one direction: it locks the unwinding of the wire without preventing the winding thereof. The drone thus moves within a half-sphere, the radius of which is the maximum length defined by the user.

Said system is made up of a motor (13) and a drum (14) on which a wire (10), having a one-direction locking mechanism, for example (X2), is wound.

The system according to the invention makes it possible to limit the possible drone crashing area if the drone malfunctions, and is intended in particular for operations on airports or critical populated or industrial regions.

### TECHNICAL FIELD OF THE INVENTION

The technical field of the invention is the set of wire-based systems for rotary wing drones. More specifically, a drone designates a flying machine remotely controlled by means of a control device. Some drones are said to have rotary wings, a designation which includes all known models of helicopter. The drones in question here are the rotary-wing drones, connected to a base on the ground via a wire, the wire often having the function of the drone power supply, or the data transfer, or the role of confining the drone in a safety zone.

### PRIOR TECHNIQUE

In the field of wired drones, it is known to use wire-based systems which comprise a wire, and a wire winder comprising a winding drum and an electric motor for driving the drum. The wire is then generally held with an adjusted tension which allows the drone to evolve easily without the wire touching the ground. For example, the documents WO2010/092253, WO2013/162128, WO2013/150442 describe wire-based systems connecting a drone to its base on the ground. The operation volume of the drone is half a sphere of radius the length of the wire. The possible area of crash of the drone is a disc of same radius. Wired drones are particularly used in sensitive areas where the drone must not be able to venture beyond certain limits. Sensitive areas are, for example, airports, highly-sensitive industrial areas, populated areas.

It is common to use as emergency lock a manually operated brake to limit the maximum length of the unwound wire. Emergency locking is usually activated by a remote pilot or a drone operator. This locking is often achieved by a brake equipping the winder of the wire. Logically, in the case of a manual locking, the possible crash zone of the drone remains determined by the total length of the wire connecting the drone to its base, because the operator remains fallible; moreover, the manual locking induces difficulties in rewinding the wire, thus disturbing the piloting of the drone.

### DESCRIPTION OF THE INVENTION

The invention consists of a secure wire-based system for drone, which overcomes the drawbacks that were mentioned above: the inventive system reliably limits the perimeter of action of the drone. The inventive system makes it possible to reduce with certainty the possible crashing of the drone on the ground to a length predefined by the user. In addition, said system retains its wire winding capabilities even in case of locking at this predefined length, and ensures on the wire the normal operating tension as soon as the drone returns to its normal flight zone, which greatly facilitates piloting the drone. Such advantages are permitted by two characteristics of said system:
an adjustment device allows the user to define a maximum length of unwound wire,
an automatic unidirectional locking device locks the drone at the maximum defined

length: said device prevents the wire from exceeding the maximum defined length, while the rewinding of the wire on its drum is still possible.

Depending on specific embodiments:
The locking mechanism is an anti-reverse ratchet mechanism;
The locking mechanism is provided by one or more extra thickness layers on the wire, adjustable or not;
The locking mechanism is a simple contact brake controlled by the length of the wire, the unidirectional characteristic of the brake is ensured by the following procedure: (i) brake activation at a wire length less or equal to the user-defined length, (ii) adjustment of the traction motor torque to its maximum, (iii) progressive release of the brake until the drum rotates, (iv) detection of the drum rotation direction, (v) if the drum rotates in the winding direction of the wire, progressive release of the brake.

Another procedure according to another embodiment provides: (i) brake activation at the user-defined length, (ii) measurement of the wire tension by a wire tension sensor for example (X9), (iii) release of the brake when the motor torque is large enough to balance the measured wire tension;
a drum rotation sensor is used to determine the length of the unwound wire;
the wire is provided with length tags and a detector counting these tags;
an automatic increase of the traction motor torque at the approach of the maximum length defined by the user ensures a gentle locking of the drone so as not to destabilize it;
a visual or auditory alarm device is intended to inform the user that the maximum length is about to be reached;
in case of malfunction of the drone, a recall procedure provides both the activation of the unidirectional locking mechanism, the opening of a drone emergency parachute, the exercise of a motor torque sufficient to bring the drone close to its base.

The invention also relates to a set comprising a drone, a wire-based system, a drone control device, the wire-based system being as described above.

### SUMMARIZED DESCRIPTION OF THE DRAWINGS

FIG. 1 is an overall view showing a flying drone (11) and an embodiment of a wire-based system (X1) equipped with an automatic unidirectional locking mechanism (X2);

FIG. 2 is a detailed view of an embodiment of a unidirectional ratchet locking mechanism (X2);

FIG. 3 is a detailed view of an embodiment of extra-thickness layers (31) on the wire ensuring the locking of the wire at the safety length;

FIG. 4 is a plan view of an embodiment of an adjustable wire locking system comprising extra thickness layers (31);

FIG. 5 is a side view of an embodiment of an adjustable locking system comprising extra thickness layers (31);

FIG. 6 is a view of an embodiment of a wire length measuring device comprising tags (61);

FIG. 7 is an embodiment of a locking system by a blocker (71) integral with the drum, the blocker locks the wire at the safety length;

FIG. 8 is an embodiment of a contact brake for the drum (14) on which the wire is wound (10);

FIG. 9 is an embodiment of a wire tension sensor (10).

More explicitly:

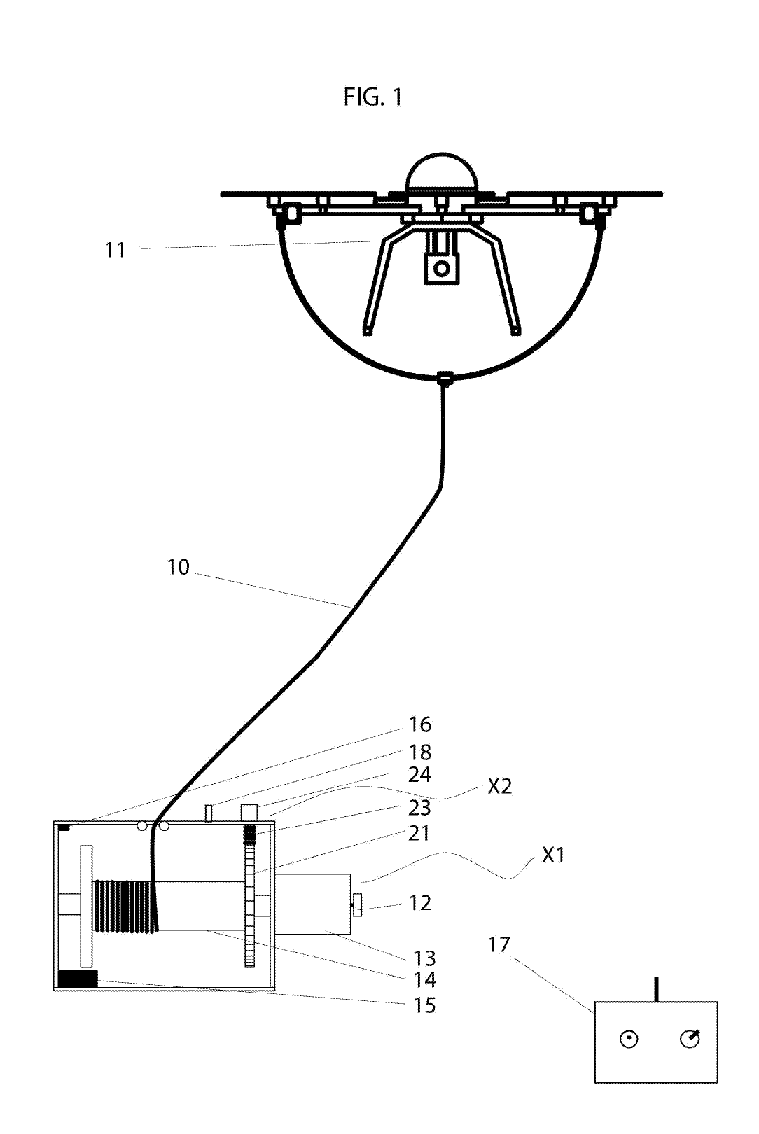

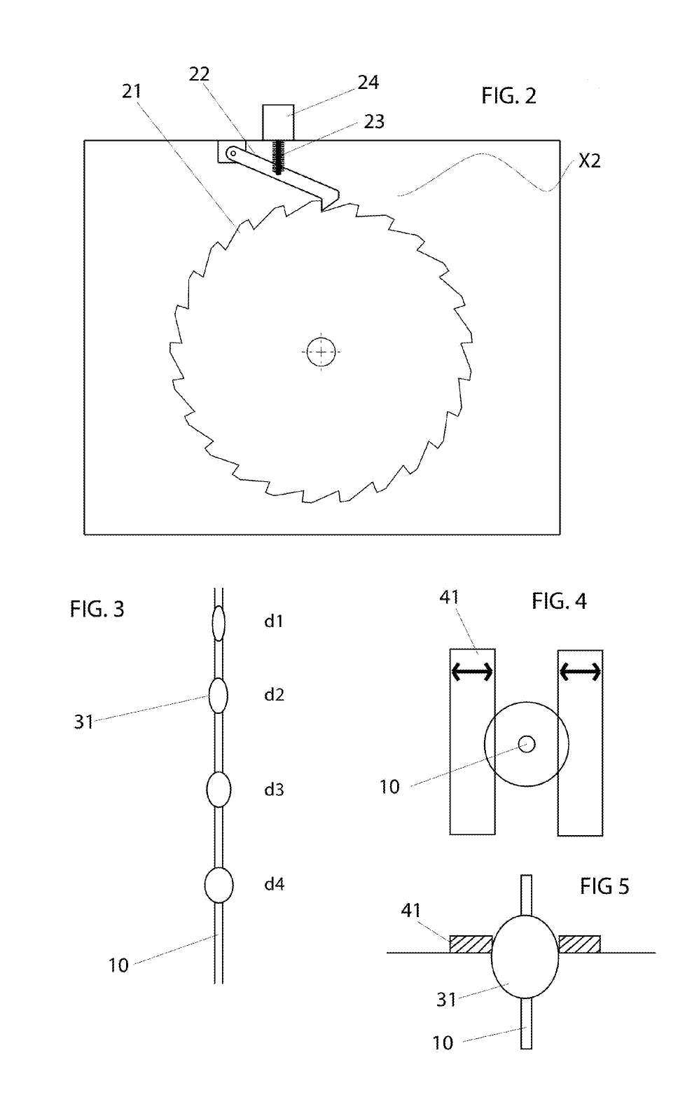

FIG. 1 shows a wire-based system (X1) for a drone (11) comprising a locking mechanism—whose different embodiments are detailed in FIGS. 2, 3, 4, 5 and 7—, a drum (14) on which a wire is wound (10), and a motor (13) which rotates the drum. The wire-based system is connected to a power supply or a battery on the ground. An important example of wire (10), often used for wired drones, consists of two electric leads for powering the drone, an optical fiber for data transfer, aramid strands to ensure a resistance to traction up to about 100 kg, and a protective sheath, the external diameter of which being about 3 mm. In a manner known per se, the drone (11) comprises, inter alia, rotor blade. The drone (11) is often equipped with various sensors, including image sensors. Most common electric drones are wireless and battery powered, which gives them limited autonomy. A wireless drone on which the battery is replaced by wired power has unlimited autonomy. In general, a backup battery is kept on the wired drone (11), to allow time for the user to land the drone (11) in case of malfunction of the wired power system. The wired drone (11) may nevertheless be entirely battery powered, since the wire (10) may be only a data transfer wire, or a traction resistant wire, or a wire containing a pipe for passing a liquid. The drone is controlled by a ground control unit (17) represented by a remote control but it can also be any form: a computer, for example. A device measuring the number of rotations of the drum, a rotary encoder (12) for instance, calculates the length of the unwound wire, and is located on the rotation axis of the drum (14). A motor (13) exerts a torque on the drum (14) for winding or unwinding the wire (10). The rotary encoder (12) informs a processing unit (15) of the unwound wire length. The processing unit (15) activates or not the unidirectional locking mechanism (X2), it also controls the motor torque by adjusting the power supply to the motor, for example. An alarm system (16), for example a loudspeaker warns the user when the length of the unwound wire is close to the maximum length defined by the user. The user can adjust the maximal wire length via a rotary switch (18).

FIG. 2 shows an example of a unidirectional locking mechanism (X2). A ratchet (22) is represented held in low position thanks to a spring (23), a toothed wheel (21) integral with the drum (14) can rotate only in one direction, that of the winding of the wire. When the processing unit (15) places the electromagnetic actuator (24) in the upward position, the ratchet is in the upward position, and the drum can rotate in both directions.

FIGS. 3, 4 and 5 show an example of a mechanism for locking the wire by extra thickness layers. Extra thickness layers (31) are fixed on the wire by the user or may be immovable. For example, when they are immovable, they can be positioned at lengths d1: 20 meters, d2: 40 meters, d3: 60 meters and d4: 80 meters. The extra thickness layers have increasing diameters. The user can adjust a distance between two bars (41) according to the desired wire (10) safety length.

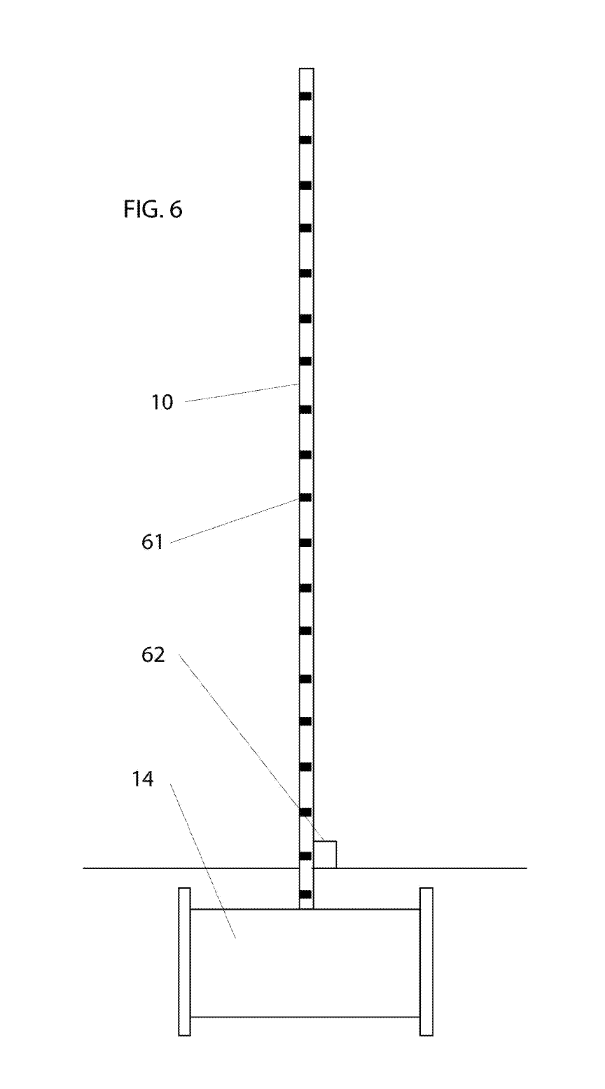

FIG. 6 shows an example of a wire length measurement device allowing the user or the processing unit (15) to know the length of the unwound wire. Tags (61), which may be optical or magnetic for example, are placed on the wire at regular intervals of about 5 cm (10). A sensor (62) detects the length of the unwound wire, and informs the processing unit (15). To measure the length of the unwound wire, one can optionally use the sensor (62) alone, or the rotary encoder (12) alone, or combine both to get a very accurate measurement.

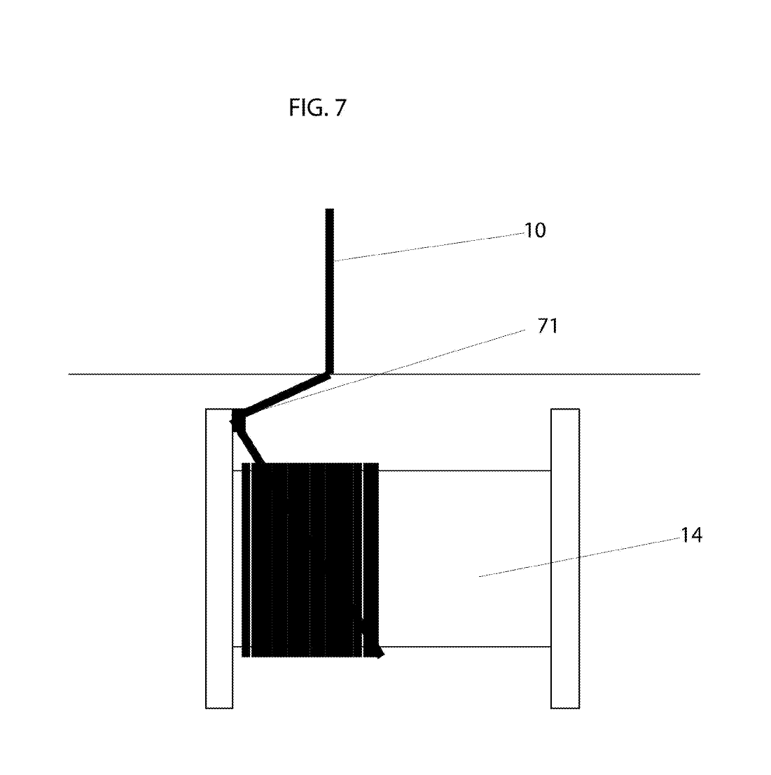

FIG. 7 shows another example of wire-locking mechanism. It comprises a mechanical locking device (71) such as a cleat or a hook in which the user blocks the wire to the desired length. This mechanism integral with the drum (14) ensures the locking of the wire in a unidirectional manner. Indeed, the wire can be unwound to the length that has been determined by the user. At this length, the drone can no longer unwind the wire since the wire is locked by the mechanical locking device.

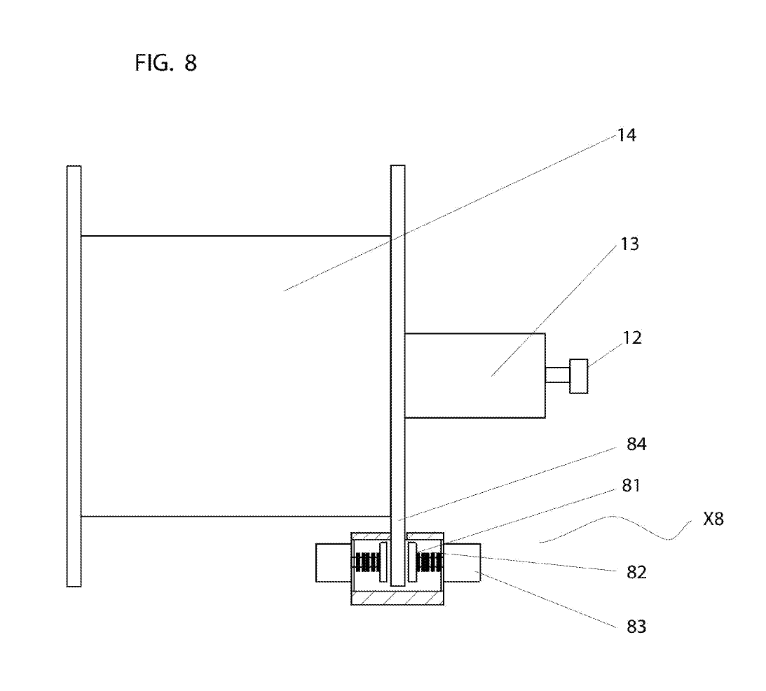

FIG. 8 shows an example of contact brake. It is composed of two powerful springs (82), two electromagnetic actuators (83) and two brake pads (81). The springs exert a force on the pads which exert a force on a disc (84) when the actuators are not powered. This friction force prevents the unwinding of the wire. When the electromagnetic actuators are energized, they compress the springs and release the disk integral with the drum (14).

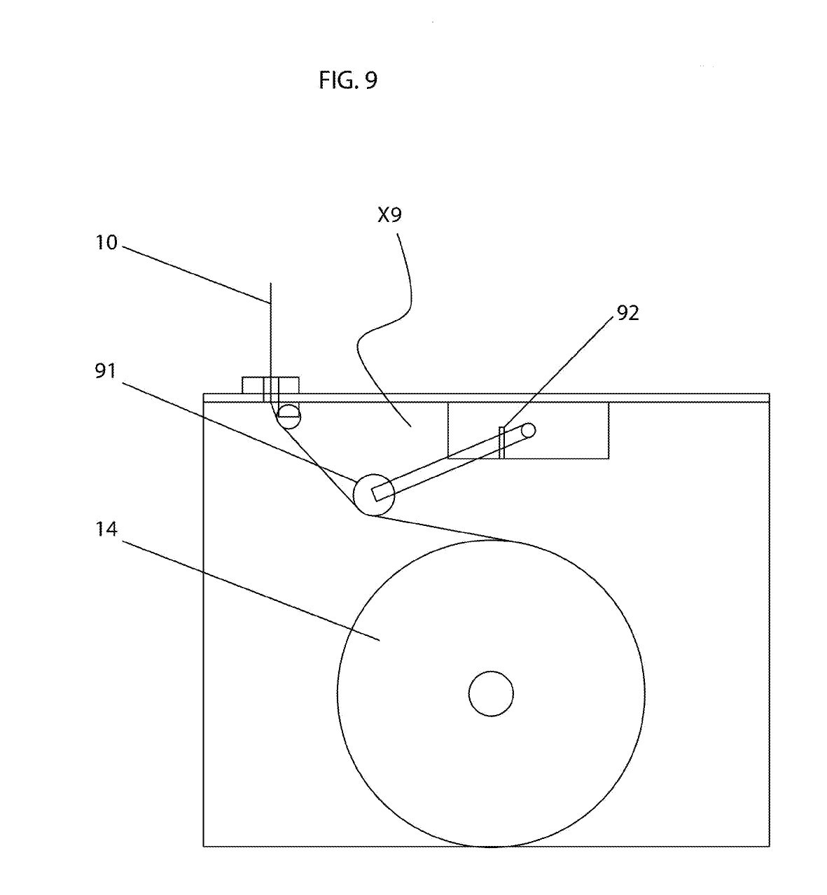

FIG. 9 shows an example of wire tension sensor. A pulley (91) is mounted on a rotating arm. The height of the arm depends on the tension of the wire. The higher the traction on the wire, the higher goes the arm. A position sensor (92) which can be, for example, a linear potentiometer, detects the position of the arm. The processing unit (15) is thus informed of the tension of the wire.

### Preferred Embodiment of the Invention

An optimal embodiment of the inventive system is now described. According to this first embodiment, a toothed wheel (21) is coaxial with the wire (10) winding drum (14) and integral with the drum. A ratchet (22) is rotating around a point connected to the base frame, while a spring (23) connects the midpoint of the pawl with an electromagnetic actuator (24). The actuator is powered by 12V. When the electromagnetic actuator is not energized, the actuator is in low position, so that the drum can only rotate in one direction: that of the winding direction. When the actuator is energized, it is in high position, so that the drum can rotate in both directions. When the drone functions normally, the actuator is powered. Via the ground control device of the drone, the user enters the maximum length of the wire to unwind. Then the processing unit (15) creates three variables in its memory that are, first, the maximum length of the wire defined by the user, secondly, the alarm length equal to the maximum length decreased by a configurable distance equal to 5 meters by default, and third, the emergency length equal to the maximum length reduced by a parameterizable distance equal to 1 meter by default. According to this first embodiment of the invention, a rotary switch (18) with 11 positions makes it possible to adjust the maximum length between 0 and 100 m in intervals of 10 m. The length of the unwound wire is measured via a rotary encoder (12). In our wire-based system according to this first embodiment, the rotary encoder accuracy is + −1 degree and the length evaluation accuracy is + −1%. When the length of the wire unwound by the drone in flight is greater than the alarm distance, an audible notification informs the user: beeps emitted by the speaker whose frequency is getting higher as the emergency length is getting closer. When the wire is unwound over a distance equal to the emergency length or higher, the beep is continuous, while at the alarm length, a beep of one-tenth of a second is heard every 4 seconds. As long as the drone (11) flies at a distance not more than the maximum length, the wire-based system provides via the motor (13) a constant tension force on the wire. The tension force is parameterizable via a rotary potentiometer on the base. The rotary potentiometer varies the traction motor torque between 0 and its maximum torque.

The value of the traction motor torque, and therefore the tension of the wire is generally defined before the flight, even if the user can readjust the position of the potentiometer during the flight. When the wire is unwound over a length equal to the maximum length, the control device stops powering the actuator (24). The ratchet (22) falls. The toothed wheel (21) and therefore the drum (14) are locked in the unwinding direction of the wire, but not in the winding direction of the wire. When the drone (11) approaches the base, the motor winds the wire (10) on the drum. The actuator (24) of the ratchet is powered again as soon as the length measured by the system is less than the emergency distance: the drum can rotate again in both directions. When the drum is locked at the wire maximum length defined by the user, and the configuration endangers the mission, the user can immediately decide to increase the maximum length of the wire by turning the rotary switch (18). The memorized variables are immediately recalculated according to the position of the switch, the actuator is powered again, and the drum is released: it can rotate both directions of winding or unwinding. Conversely, in case of emergency, if the user or the processing unit (15) realizes that he or it must lock the drone (11) and repatriate it, he or it can set the maximum length to Om, which results in powering off the actuator: the drone can no longer move away from the base, it can only get closer. In the event of a malfunction of the drone, for example the detection of its fall by an acceleration sensor, a procedure provides for the opening of a rescue parachute of the drone (11), the activation of the unidirectional locking mechanism, and a traction motor torque which, according to this embodiment of the invention, ensures a tension of the wire equal to the weight of the drone. For example, if the wire has an angle of 45° with the vertical when the malfunction occurs, the drone is brought back to the ground with a velocity vector whose angle to the vertical is equal to 22.5°. This further reduces the possible crash area of the drone.

Variations of this preferred embodiment include replacing the ratchet mechanism with an equivalent mechanism of jamming rolling elements, or an equivalent mechanism of obstruction cams. These equivalent mechanisms are well known to people working in this field of research, those who manufacture freewheels, and do not require further description. The alarm described in this embodiment is optional, although it greatly facilitates the control. The alarm can advantageously be retransmitted at the level of the ground control unit loudspeakers. On the ground control unit can also appear the measure of the unwound wire length measured by the rotary encoder, as well as the maximum length defined by the user. The unwound length may be highlighted in bold red when the alarm length is exceeded. The rotary switch (18) can be removed from the base and the user-defined maximum length set in meters directly on the ground control unit. Optionally, to avoid a sudden locking of the drone that may destabilize it, one can linearly increase the motor torque between the emergency distance and the maximum distance defined by the user.

### Other Embodiments of the Invention

We describe now two other embodiments of the inventive system, the advantages of which can be easily understood.

In a second embodiment of the invention, the toothed wheel is replaced by a mechanism for locking the wire by four thickness layers (31) permanently fixed on the wire (10). These extra thickness layers can have the shape of balls. The first ball has a diameter of 4 mm and is fixed at 20 m from the drone, the second a diameter of 5 mm and is fixed at 40 m from the drone, the third has a diameter of 6 mm and is fixed at 60 m from the drone, the fourth with a diameter of 7 mm is fixed at 80 m from the drone. The wire (10) is initially fully wrapped around the drum except for the end of the wire that passes through a hole. This end is connected to the drone. The hole has an adjustable diameter and provides 5 positions: 20 m (hole diameter 3.5 mm), 40 m (hole diameter 4.5 mm), 60 m (hole diameter 5.5 mm), 80 m (hole diameter 6.5 mm), 100 m (hole diameter 7.5 mm). When the hole diameter is set to a position, for example 40 m, the hole can let the wire unwind to a length equal to 40 m from the hole, but not more. Indeed, the first ball which corresponds to 20 m can pass through the hole, but the second ball cannot pass, since its diameter of 5 mm is superior to the 4.5 mm of the hole. The diameter of the hole is simply adjusted by two bars (41) of metal that approach or move away from the center of a 10 mm diameter hole. The hole section can be adjusted by any other equivalent mechanism. According to certain advantageous configurations, the edges of the bars are machined so that the balls slide well. Also, the balls may be replaced by more complex shapes, which may be flexible, which slide better in the hole and do not affect the winding of the wire around the drum.

According to another equivalent variant, the wire does not have a ball at the start. The wire is fully wound on the drum except the end of it which passes through a hole width adjustable in two positions only: 5 mm diameter and 15 mm diameter. The user sets the hole to the 15 mm diameter and unwinds the wire through the hole to the desired maximum length. When the desired unwound length is reached, the user sets a8 mm-diameter ball on the wire. Then, the user completely rewinds the wire around the drum and adjusts the diameter of the hole to the 5 mm position. When the drone (11) takes off and unwinds the wire, the ball abuts against the hole. The wire cannot unwind any further but rewinding remains possible. This embodiment provides a unidirectional locking system that is very simple to achieve.

In a third embodiment, a disc (84) is coaxial with the winding drum of the wire and integral with the drum (14). A brake (X8) is integral with the base frame and clamps the disc. By default, the brake clamps the disc with two strong springs (82) and when the brake is powered, the brake comes loose. The user sets the maximum length of the unwound wire with a rotary switch (18) as in the first embodiment. The processing unit creates two variables that are the maximum length and the emergency length, as in the first embodiment. When the wire (10) is unwound to a distance less than the emergency distance, the normal operating motor torque set via the rotary potentiometer is used. When the wire is unwound over a length greater than the emergency length, the motor torque is linearly increased until reaching its maximum torque to the maximum distance defined by the user. If the maximum distance is reached, the brake is no longer powered and clamps the disc thanks to the two powerful springs. The two powerful springs are powerful enough to lock the drum even when the wire exerts a force equal to its tensile breaking force, which is about 100 kg on our system. The traction motor torque remains at its maximum. Immediately after the locking, the brake is powered again with a gently increasing voltage which gradually releases the pressure on the disk until the drum rotates. Then, the rotary encoder (12) detects the drum rotation direction. If the rotation is in the direction of wire winding, the brake is immediately reopened, so that the wire is rewound; the motor torque is still linearly dependent on the length: the torque is at its maximum at the maximum length, and at its normal operating length at the emergency length. If conversely the rotary encoder detects a rotation in the unwinding direction, the brake is immediately reactivated: the slip due to this procedure is low, in the range of 1 cm, even if the wire tension of 100 kg. Every 10 seconds, the progressive brake release procedure is repeated, so that in an unfavorable case, the maximum defined length is exceeded centimeter after centimeter. When the maximum length is exceeded by more than 1m, the brake is permanently blocked.

The user can manually unlock the brake when he regains control of his drone: manually increasing the maximum defined length on the base results in an immediate recalculation of the two variables of the processing unit, and thus results in releasing the brake.

The embodiments and variants considered above can be combined with one another to generate new embodiments of the invention.

### POSSIBILITIES OF INDUSTRIAL APPLICATIONS

The inventive system finds its applications for any user wanting to reliably limit the possible drone crash area in case of a drone malfunction. Said system is thus particularly intended for airports, populated areas, or highly sensitive industrial areas.

1) Wire-based system (X1), connecting a drone to its base on the ground, comprising:
at least an electric wire (10) or a data transfer wire or a mechanical tension wire,
at least a drum (14) for winding the wire,
at least an electric motor (13) for driving the drum,
at least a wire locking mechanism,
Said system is characterized by the fact that it comprises both:
an adjustment device allowing the user to define a maximum length of unwound wire;
an automatic locking device at the maximum user-defined length, the locking device being unidirectional: it makes it impossible to exceed the maximum length, while the rewinding of the wire on its drum remains possible.

2) System of claim 1 wherein the unidirectional locking mechanism (X2) is a ratchet wheel.

3) System of claim 1 wherein the locking mechanism is provided by one or more extra thickness layers (31) on the wire, adjustable or not.

4) System of claim 1 wherein the locking system is a contact brake (X8) depending on the length of the wire, the unidirectional characteristic of the brake being provided by one of the following procedures:
Procedure 1: (i) brake activation at a wire length less or equal to the user-defined length, (ii) adjustment of the traction motor torque to its maximum, (iii) progressive release of the brake until the drum rotates, (iv) detection of the drum rotation direction, (v) if the drum rotates in the winding direction of the wire, progressive release of the brake.
Procedure 2: (i) brake activation at the user-defined length, (ii) measurement of the wire tension by a wire tension sensor for example (X9), (iii) release of the brake when the motor torque is large enough to balance the measured wire tension.

5) System of claim 1 wherein the wire is physically blocked to the user-defined length by a blocker (71) directly on the drum.

6) System of any of the preceding claims wherein a drum rotary encoder (12) determines the length of the unwound wire.

7) System of any of the preceding claims wherein:
the wire is covered with length tags (61)
a sensor (62) counts these tags.

8) System of any of the preceding claims, ensuring a gentle locking to not destabilize the drone, by gradually increasing the traction motor torque (13) when approaching the user-defined maximum wire length.

9) System of any of the preceding claims wherein a device informs the user that the maximum length is about to be reached.

10) System of any of the preceding claims wherein a procedure implemented in a processing unit (15) provides:
the activation of the unidirectional locking mechanism,
the opening of a rescue parachute for the drone (11),
the triggering of a sufficient motor torque (13) to repatriate the drone to its base.

11) A set comprising a wire-based system (X1) of any of the preceding claims and:
a drone (11),
a ground control unit of the drone (17),
and a wire (10) connecting the drone to its base.
